(19) United States
(12) Patent Application Publication
(10) Pub. No.: US 2015/0084835 A1
(43) Pub. Date: Mar. 26, 2015

(54) SPHERICAL RESONATOR FREQUENCY SELECTIVE SURFACE

(71) Applicant: HARRIS CORPORATION, Melbourne, FL (US)

(72) Inventors: Christopher Snyder, Melbourne, FL (US); Stephen Landers, Satellite Beach, FL (US); Gregory M. Jandzio, Melbourne Village, FL (US); Maria Cardinal, Indian Harbour Beach, FL (US)

(73) Assignee: HARRIS CORPORATION, Melbourne, FL (US)

(21) Appl. No.: 14/032,708

(22) Filed: Sep. 20, 2013

(51) Int. Cl. H01Q 15/00

(52) U.S. Cl. CPC H01Q 15/0053
USPC 343/911 R; 343/909; 427/58

(57) ABSTRACT

A frequency selective surface includes resonators (104) which are spherically shaped and have an arrangement which defines a periodic array (103) of rows (112) and columns (114). The periodic array extends in at least two orthogonal directions. A registration structure (602) is provided and arranged so that it at least partially maintains a position of each of the resonators in a predetermined spatial relationship with respect to adjacent ones of the plurality of resonators to define the array. Each of the resonators is formed of a conductive material and is electrically insulated from adjacent ones of the resonators forming the array by an insulator material.

### BACKGROUND OF THE INVENTION

1. Statement of the Technical Field

The inventive arrangements relate to structures having tailored responses to certain radio frequencies and more particularly to structures which comprise frequency selective surfaces.

2. Description of the Related Art

A frequency selective surface (FSS) is a physical structure, that functions to allow radio frequency (RF) waves of certain frequencies to pass through the structure with minimal attenuation while causing radio waves of other frequencies passing through the same structure to experience significant attenuation. As such, a FSS essentially behaves as a spatial filter of electromagnetic waves. A common type of frequency selective surface functions by exploiting the occurrence of resonant interactions with uniform conductor elements arranged in the form of a periodic array.

Frequency selective surfaces are commonly formed from one or more cascaded layers comprising two-dimensional planar surfaces. Numerous different resonant shapes have been employed for purposes of creating such frequency selective surfaces. For example, geometric element shapes used to form a frequency selective surface can include circles, squares, and hexagons. Single or multiple cascaded layers of such periodic arrays can be used in combination. As noted, most of these frequency selective surfaces are comprised of two- dimensional arrays of conductive elements. A three dimensional frequency selective surface comprising a plurality of cylindrical elements has been described by Azemi et al. in “3D Frequency Selective Surfaces,” Progress in Electromagnetics Research C, Vol. 29, 191-203, 2012.

### SUMMARY OF THE INVENTION

The inventive arrangements concern a frequency selective surface (FSS) and a process for making same. The FSS includes resonators which are spherically shaped and have an arrangement which defines a periodic array of rows and columns, or an organized lattice structure. The periodic array extends in at least two transverse directions. A registration structure which is provided and arranged so that it at least partially maintains a position of each of the resonators in a predetermined spatial relationship with respect to adjacent ones of the plurality of resonators to define the array. Each of the resonators is formed of a conductive material and is electrically insulated from adjacent resonators by an insulator material.

The method of forming a frequency selective surface includes arranging a plurality of spherically shaped conductive resonators to form a periodic array comprised of rows and columns, or an organized lattice structure. The process continues by conforming the periodic array to a planar or non-planar surface. Thereafter, a diameter of the spherically shaped conductive resonators and a spacing between adjacent ones of the spherically shaped conductive resonators is selected. These values are selected to obtain a predetermined frequency response for the frequency selective surface. Thereafter, a positional relationship among the spherically shaped conductive resonators in the lattice is maintained by securing the plurality of spherically shaped conductive resonators using a registration structure.

### BRIEF DESCRIPTION OF THE DRAWINGS

Embodiments will be described with reference to the following drawing figures, in which like numerals represent like items throughout the figures, and in which:

FIG. 1 is a top view of an exemplary frequency selective surface that is useful for understanding the present invention.

FIG. 2 is an enlarged view of a portion of the frequency selective surface in FIG. 1.

FIG. 3 is a cross-sectional view of the frequency selective surface in FIG. 1, taken along line 3-3.

FIG. 4 is an enlarged cross-sectional view of a portion of the frequency selective surface shown in FIG. 3.

FIG. 5 is a cross-sectional view of a frequency selective surface similar to the frequency selective surface shown in FIG. 1, and which includes both convex and concave portions.

FIGS. 6A and 6B are cross-sectional views of a plurality of spherical resonator elements during a potting process.

FIGS. 7A and 7B are drawings which are useful for understanding an alternative type of core material.

FIGS. 8A and 8B are cross-sectional views of an alternative embodiment of the invention in which a plurality of spherical resonators are registered using additional tooling and then potted.

FIG. 9 is a flowchart that is useful for understanding the invention.

### DETAILED DESCRIPTION

The invention is described with reference to the attached figures. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operation are not shown in detail to avoid obscuring the invention. The invention is not limited by the illustrated ordering of acts or events, as some acts may occur in different orders and/or concurrently with other acts or events. Furthermore, not all illustrated acts or events are required to implement a methodology in accordance with the invention.

Traditional frequency selective surface (FSS) structures are manufactured using common printed wiring board (PWB) techniques. These types of FSS structures are generally limited to structures comprising multi-layer planar surfaces. The transmission/reflection variation of an FSS over frequency is determined by the inherent resonance of the elements comprising the FSS. The resonances are proportional to the capacitive coupling between adjacent elements. Maximum coupling is limited in the case of a PWB by minimum gap requirements which are determined by manufacturing tolerances.

In practice, the size of PWB type FSS structures is limited by the largest available panels and etchant tank size. Another limitation associated with traditional FSS structures arises when an FSS is needed to conform to a contoured surface. Planar surfaces do not readily map to an arbitrarily shaped surface. Applying a planar PWB to arbitrarily shaped surfaces causes dimensional distortion of the resonant cells comprising the FSS. Such dimensional distortion of the FSS resonant elements and/or the spacing between such elements can adversely affect the pass-band and/or stop-band performance of the FSS. The foregoing problems are solved by using spherical resonators to replace conventional planar elements.

Conventional printed resonator elements in FSS structures are replaced by conductive spheres. The spheres can be selectively constructed to support two different methods for manufacturing the FSS structures. According to one approach, the spheres are provided with a dielectric coating which has a thickness that is half of the desired spacing between the resonator elements. This coating allows the spheres to touch at the appropriate distance, thereby effectively defining the spacing between elements. In this approach, registration of the resonator elements can be thought of as occurring locally with respect to the spheres, since the spacing is determined by the coating provided on the sphere, and without any external tooling. In a second approach that shall be described herein, the spacing of the spherical resonator elements is controlled by additional tooling. The additional tooling can be used to temporarily hold the resonators elements in position while they are secured by other means. In such a scenario, the tooling can be removed after the spherical resonator elements have been secured in their permanent positions by other means. Alternatively, a type of tooling can be used that remains as part of the FSS after the structure has been completed.

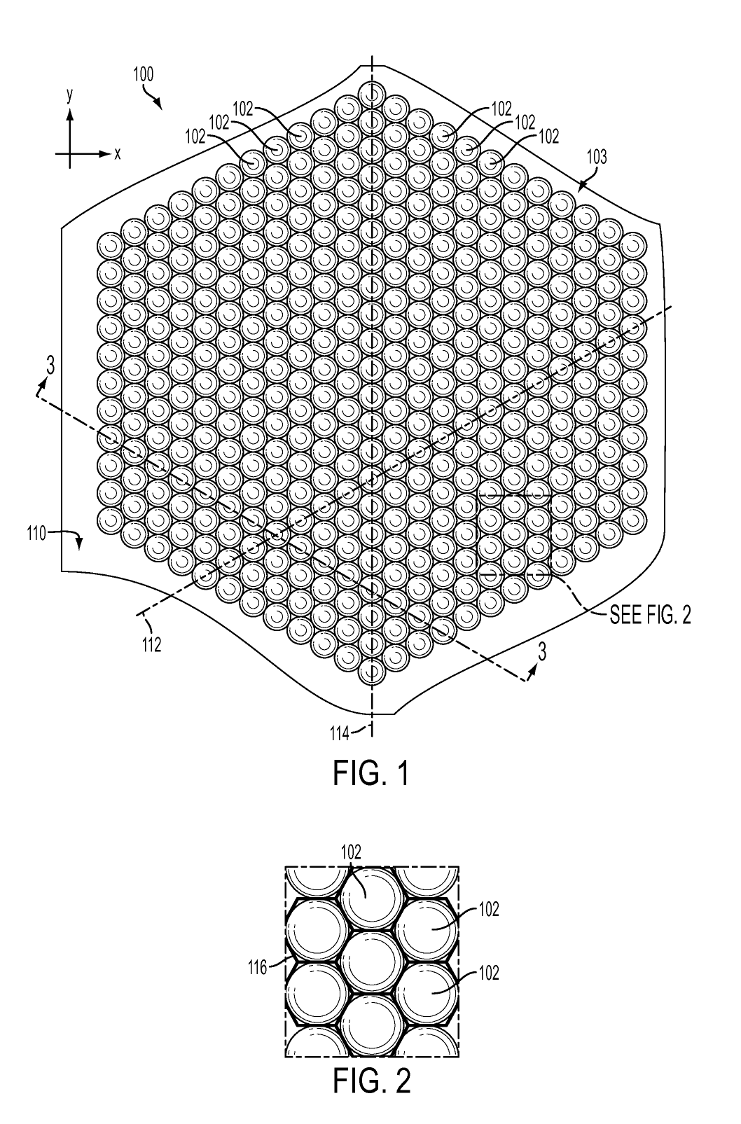

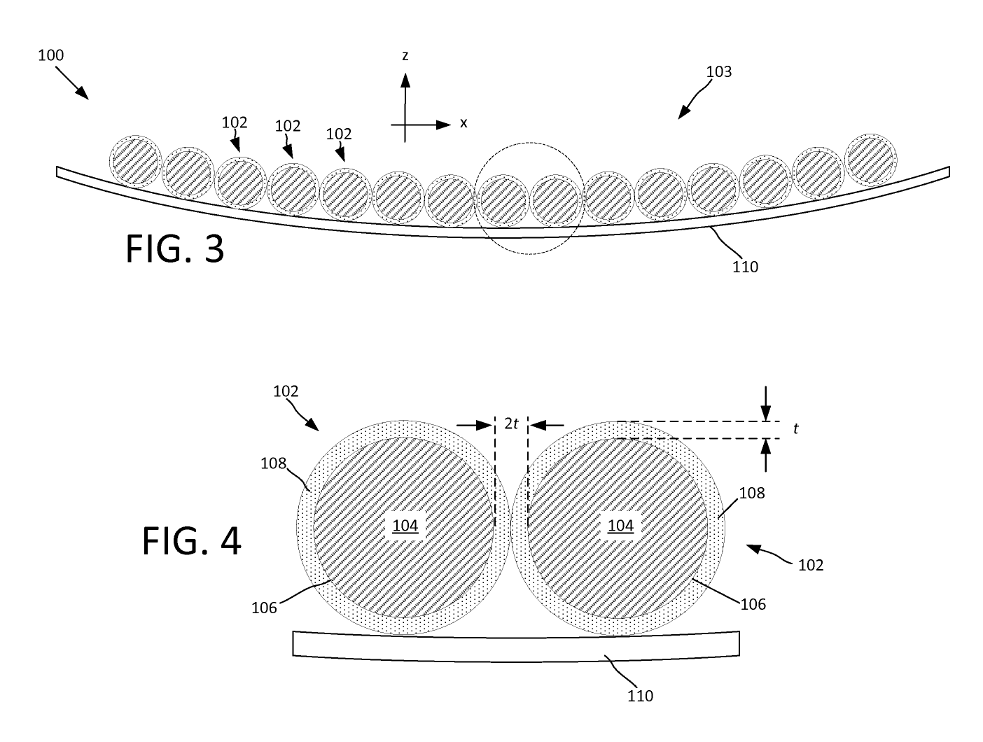

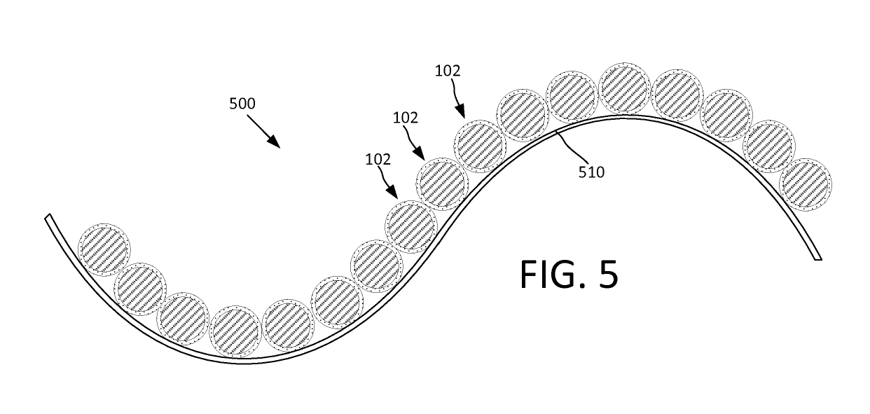

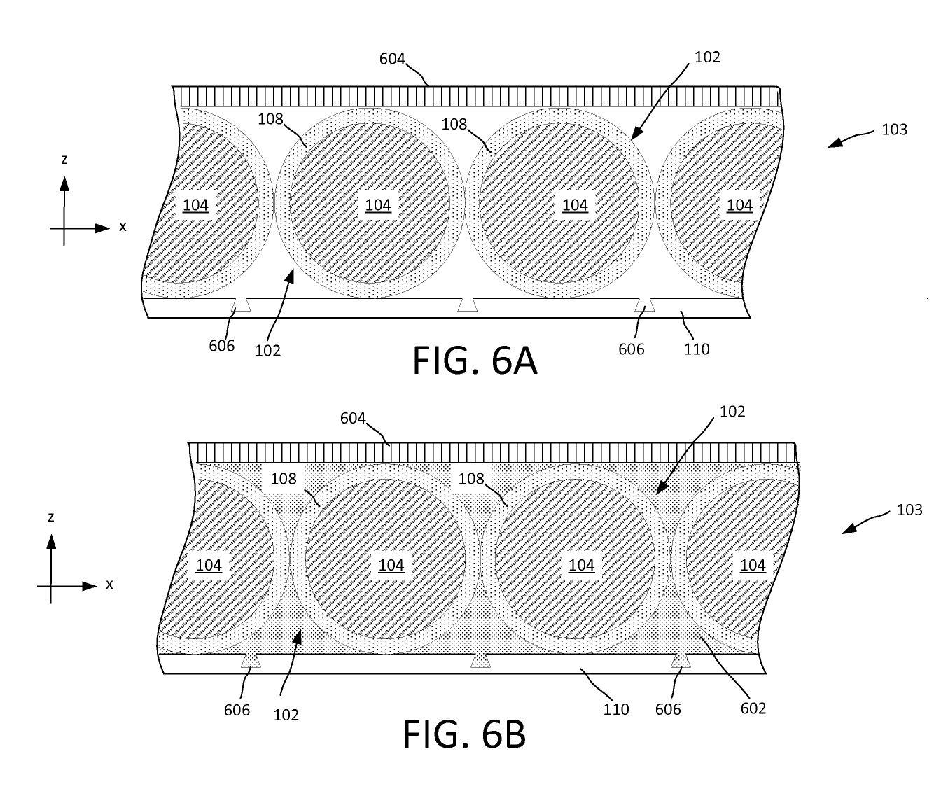

Referring now to FIGS. 1-4 there is shown an FSS 100 that uses spherical elements 102. The spherical elements 102 are comprised of resonators 104. The resonators 104 have a spherical surface 106 that is formed of a conductive material such as copper (Cu). The spherical elements 102 are disposed on a surface 110 to form an array. The surface 110 can be formed of a dielectric material that is suitable for supporting the spherical elements 102. In certain scenarios, other materials and components can also be used to at least partially form the surface 110. The surface 110 has an arbitrary shape which, in the example shown in FIG. 3, is generally concave. However, the inventive arrangements are not limited in this regard and the surface on which the spherical elements are disposed can have any contour. For example, there is shown in FIG. 5 an FSS 500 that is similar to FSS 100, and which includes a surface 510 that has both concave and convex portions.

It can be observed in FIG. 1 that the spherical elements 102 are arranged in rows and columns or an organized lattice structure to form a periodic array which extends in at least two transverse directions. For example, in FIG. 1, the array extends in two orthogonal directions aligned with at least the x and y axis. It can be observed in FIG. 1, that a row (e.g. a row defined along line 112) is transverse to a column (e.g. a column defined along line 114), but the rows and columns are not necessarily orthogonal to each other. According to an aspect of the invention the spherical elements can be arranged to form a periodic lattice structure in which certain patterns appear at repeated and regular spacing. For example, when arranged as shown in FIGS. 1 and 2, the spherical elements naturally fill a hexagonal lattice 116, to thereby produce a honeycomb-like structure as shown. Other lattice structures are also possible and the invention is therefore not limited to hexagonal lattice structures.

A registration structure is provided which at least partially maintains a position of each of the resonators 104 in a predetermined spatial relationship with respect to adjacent ones of the resonators for purposes of defining the array 103. The registration structure can include one or more components which are designed to maintain spacing between resonators and/or control a relative position of the resonators. For example, the registration structure can include a dielectric layer 108 which is disposed on the spherical outer surface 106 of resonators 104. The dielectric layer 108 formed of an insulating material which surrounds each resonator 104. As shown in FIG. 4, the dielectric layer 108 advantageously has a uniform thickness t which is half of the desired spacing distance 2t between spherical surfaces 104 of adjacent resonators. The uniform thickness of the dielectric layer is advantageous because it allows the spherical elements to maintain the spherical shape defined by the resonators. The thickness of the dielectric layer or coating helps to maintain a desired spacing between adjacent resonators. Spacing between resonator elements is a critical aspect of FSS design and must be strictly controlled in order to obtain a desired pass band and stop band characteristic for the FSS. Accordingly, the dielectric layer 108 provides the potential for self-alignment or self-registration of the resonators 104. The necessary spacing between resonators can be controlled in such an arrangement by selecting the thickness t of the dielectric layer 108 to be ½ of the desired spacing between resonators.

The registration structure will advantageously include one or more additional components. For example, the registration structure can include a core 602 which extends in at least two orthogonal directions corresponding to extent of the array 103 in the x and y directions. The core is formed of a non-conductive dielectric material and secures the resonators 104 in position relative to each other. As such, the core 602 can be a dielectric material which is flowed into the interstitial areas between the spherical elements 102. The flowed dielectric material can then be subjected to a curing process which causes it to harden to a solid or gelatinous consistency. In the electronics field, potting refers to the encapsulation of electronic components by filling a completed assembly with a flowable compound which is then hardened. Thermo-setting plastics or silicone rubber gels are sometimes used for this purpose.

The process described herein which involves flowing dielectric material between the spherical elements 102 can be thought of as a potting process. An exemplary potting material for this purpose would be a cyanate ester compound which provides minimal loss and satisfactory dielectric properties after curing. Still, the invention is not limited in this regard and any other suitable dielectric material can be used for this purpose. After being cured, the dielectric material forming the core 602 will harden and secure the spherical elements in relative position to each other. The core material is advantageously secured to the surface 110 to maintain the resonators (and the FSS generally) in a conformal relationship with respect to the surface 110. The core material can be secured using mechanical fasteners, or can be adhered to surface 110. In some scenarios, it can be advantageous for the surface 110 to have channels or grooves 606 formed therein. The flowed dielectric core material can be allowed to flow into the grooves 606 during the potting or filling process to allow the cured core material to be more effectively interlocked with the surface 110.

In certain scenarios, it may be convenient to provide at least one flow-limiting surface 604. The flow-limiting surface 604 can be useful to limit the space or volume into which the dielectric material forming the core 602 is permitted to flow. The flow-limiting surface 604 can be removed after the dielectric material has been cured or it can be permitted to remain in place. If the flow-limiting surface 604 remains in place, it is advantageously formed of a low loss dielectric material.

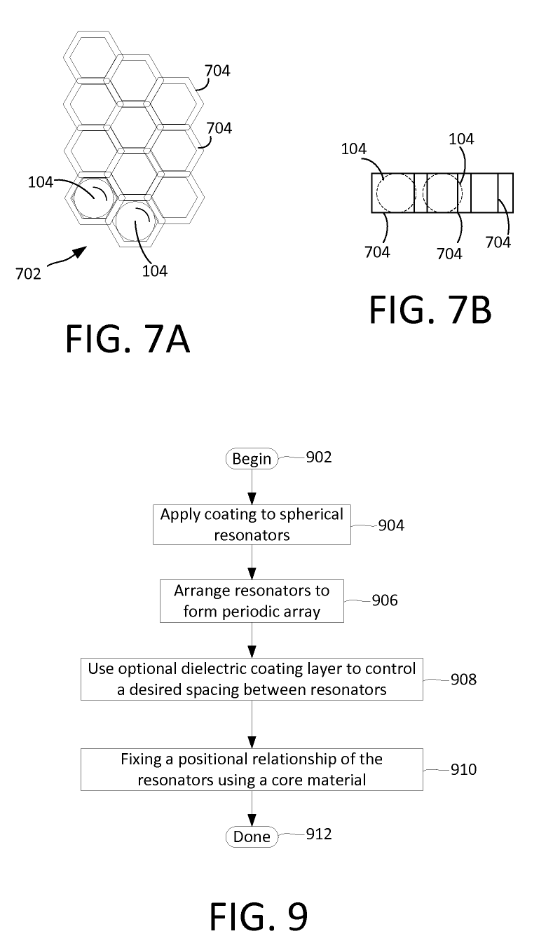

The core used to position and secure the spherical elements 102 can also be provided by other means. For example, the core can be pre-formed as a rigid or flexible web which defines a plurality of interstitial cells. Such an arrangement is illustrated in FIG. 7 which shows that a core 702 is comprised of a plurality of interstitial cells 704. The core 702 is formed of a dielectric material which can be rigid or flexible. The core 702 secures the spherical elements 104 in relative position with respect to one another. The spherical elements can be held in position within the interstitial cells by mechanical fasteners, frictional force, adhesive or potting material. The core material can be secured using mechanical fasteners, or can be adhered to surface 110. Alternatively, any other suitable registration structure can be used with spherical elements 102, provided that the registration structure is capable of maintaining the spherical elements in the required spacing and position needed to form the lattice structure of the FSS. Accordingly, the invention is not intended to be limited to the particular registration structure or registration components described herein. Selection of a core 702 with appropriate dielectric properties obviates the need for the dielectric coating 108 of the spherical resonators.

The resonator 102 which form the periodic array can be aligned in a plane which extends in the at least two orthogonal directions and through a center of each of the plurality of resonators. However, the periodic array of resonators 102 can optionally be arranged to conform to a surface contour that extends in a least one direction transverse to the two orthogonal directions over which the array extends. For example, the periodic array shown in FIG. 1 extends in the x and y directions, but can also extend in the z direction as shown in FIG. 3. The extension in the z direction is due to surface contours to which the FSS 100 is conformed. In this regard, the centers of the spherical elements forming the FSS can be thought of as defining a plurality of points. These plurality of points together define an array surface. When the FSS is formed on a planar surface, the array surface will also be planar. However, when the FSS is conformed to a contoured surface (a surface that extends in at least one direction transverse to the x and y directions shown in FIG. 1, then the array surface will be non-planar. In such a scenario, the array surface also extends in at least one direction (e.g. +/−z direction) which is transverse to the at least two orthogonal directions (x and y directions in FIG. 1).

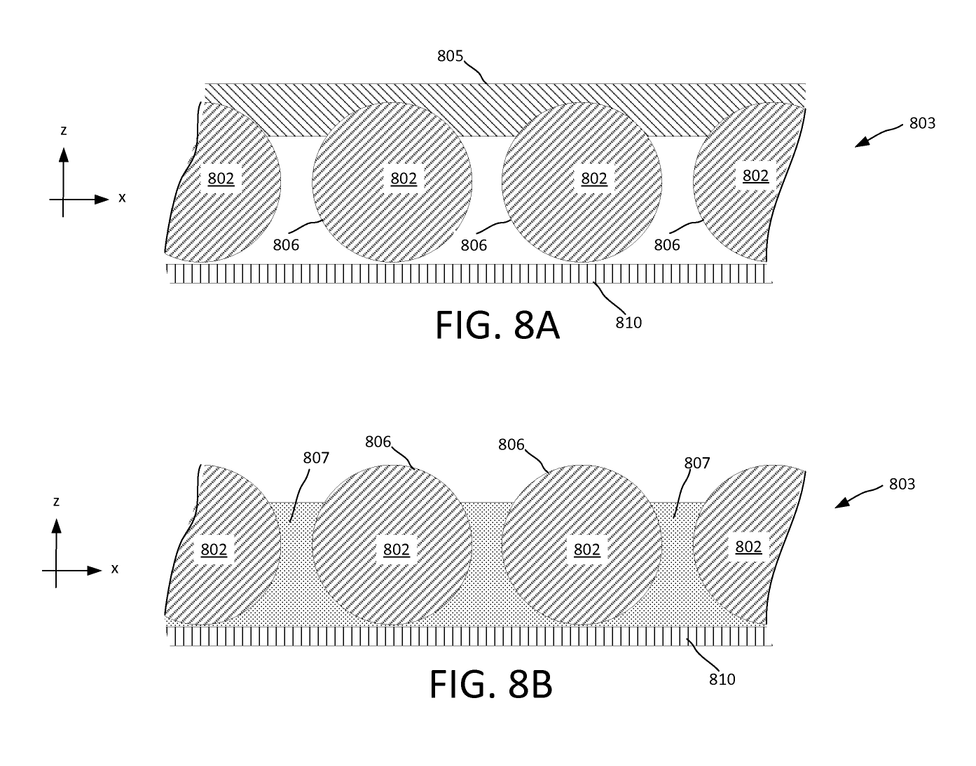

As explained above, the resonators 102 may be surrounded by a dielectric coating layer 108 of predetermined thickness, and this dielectric layer can function as part of the registration structure for the FSS. To this end, the dielectric coating layer can potentially obviate the need for additional tooling because it maintains a desired spacing between spherical elements. Still, there are some scenarios where additional tooling may potentially be acceptable or even desirable. In those scenarios, the dielectric layer 108 can be omitted. As shown in FIGS. 8A and 8B, a plurality of spherical elements 802 can be disposed on a surface 810 in a manner similar to that described with respect to FIGS. 1-4. The spherical elements 802 comprise resonators which are exclusive of a dielectric coating. The spherical elements have a spherical surface 806 formed of a conductive material such as copper (Cu). As such, the spherical elements 802 are similar to the resonators 104.

Due to the fact that the spherical elements 802 do not have a dielectric coating layer, additional tooling is necessary to position the spherical elements during a manufacturing process. In this regard, physical spacing is provided between adjacent spherical elements so that the resonators are not physically in contact with adjacent resonators. Exemplary tooling 805 is shown in FIG. 8A. The exemplary tooling 805 includes concave portions which are designed to receive a portion of the spherical surfaces 806. Additional restraining structure (not shown) can be provided to hold the exemplary tooling in place relative to the surface 810 and thereby hold the spherical elements 802 in a fixed relative position during the assembly process. In this scenario, the spacing between the resonators and their relative positions is maintained by the tooling 805.

A core for the array 803 is provided in a manner similar to core 602 described above. More particularly, a core 807 formed of a dielectric material can be flowed into the interstitial spaces between resonators and then cured to form a rigid or flexible registration structure. The registration structure formed by the core holds the resonators in their desired position to form the periodic lattice or array. The core 807 also serves to electrically insulate adjacent resonators. Accordingly, in the scenario shown, a dielectric layer surrounding the resonators is not required.

In the arrangement shown in FIG. 8B, the resonators are only partially contained within the core 807. However, the invention is not limited in this regard and the core material can extend further in the z direction to fully contain the resonators. The tooling 805 can be used as a flow-limiting surface to effectively limit the space within which the dielectric material forming the core 807 can be flowed. The core material can then be cured as previously described and the tooling can be removed. The core material 807 can be secured to the surface 810 using means similar to those described herein with respect to core 602. A suitable registration structure can also be provided by using a core material similar to that which has been described herein with respect to FIGS. 7A and 7B. Alternatively, any other suitable registration structure can be used with spherical elements 802, provided that the registration structure is capable of maintaining the spherical elements in the required spacing and position needed to form the lattice structure of the FSS. Accordingly, the invention is not intended to be limited to the particular registration structure or registration components described herein.

The inventive arrangements also describe a method of forming a frequency selective surface. The method is shown in FIG. 9. The method begins at step 902 and continues to step 904 where a dielectric layer is applied to a conductive spherical resonator. This step can include selecting a diameter of the spherically shaped conductive resonators and a thickness of the dielectric layer to obtain a predetermined frequency response for the frequency selective surface. The dielectric layer can be applied using any suitable technique, provided that it results in generally uniform thickness of the dielectric layer around the conductive sphere. For example, the dielectric layer can be applied using vapor deposition, spray on coatings (which can be applied in a vacuum to ensure greater uniformity), powder coating, and so on. As is known in the art, a sphere can be rotated as the coating layer is being applied to ensure a more uniform thickness. A spherical resonator can also be disposed in a mold and the dielectric can be flowed around the resonator and cured to form an outer layer or skin on the spherical resonator.

In some instances, the dielectric layer which surrounds the spherically shaped conductive resonator can include minor imperfections or discontinuities in the layer. These imperfections or discontinuities in the uniformity of the dielectric layer can include a pattern of dimpling or even small perforations of the dielectric layer. Such discontinuities are acceptable provided that they do not substantially interfere with the registration and insulating functions performed by the dielectric layer. A conductive resonator with such discontinuities in the dielectric layer is nevertheless considered to be surrounded by a uniform dielectric layer for purposes of the present invention.

After applying the optional dielectric coating layer, the spherical resonators are arranged at 906 to form a periodic array. The periodic array can be comprised of rows and columns forming a hexagonal lattice structure as shown in FIG. 1. The array can be disposed on a planar surface or a contoured (non-planar) surface as described. The process continues to step 908 where the dielectric layer is used to maintain a desired spacing between adjacent ones of the resonators comprising the periodic array and to electrically insulate the adjacent ones of the plurality of spherically shaped conductive resonators. Thereafter, in step 910 the positional relationship of the resonators within the lattice structure can be fixed by using a dielectric core material. This step can involve flowing and then curing the core material as described above. Alternatively, a web of non-conductive interstitial cells can be provided by using a core material as shown and described in relation to FIGS. 7A and 7B. Upon completion of step 910, the process can terminate in step 912.

Various factors can affect the frequency response characteristics (e.g. pass-band, stop-band and insertion loss) of an FSS as described herein. For example, the size of the spherical resonators, the spacing between adjacent resonators, the thickness of the dielectric layer, the lattice structure and array pattern can all affect the frequency response. Other relevant factors can include the electrical characteristics of the material forming the core and the dielectric layer. For example, the permittivity, permeability and loss characteristics of the material forming the core and the material forming the dielectric layer will affect the frequency response of the FSS. Further, it should be appreciated that one or more of the electrical characteristics associated with the core can be different as compared to those of the dielectric layer. All of the foregoing factors should be considered when selecting the various design features of an FSS as described herein. As will be appreciated by those skilled in the art, the selection of the various design features can be facilitated by use of computer modeling software. Any of several well-known computer software applications can be used for this purpose.

An FSS as described herein has many advantages over conventional type FSS structures which are formed on planar printed wiring boards. The spherical resonator FSS also has advantages over FSS structures that use three-dimensional resonator which are non-spherical. One advantage of an FSS as described is due to the use of resonators which are spherical. The use of spherical resonators minimizes the negative performance impact that normally results when a conventional FSS structure formed of a planar PWB is made to conform to arbitrary surface contours. The spherical nature of the resonators allows the resonator elements to conform to nearly any contoured surface without altering the geometry of the array. Unlike conventional arrangements, the FSS apparatus and methods described herein require no photo-mask and do not use traditional PWB techniques.

All of the apparatus, methods and processes disclosed and claimed herein can be made and executed without undue experimentation in light of the present disclosure. While the invention has been described in terms of preferred embodiments, it will be apparent to those of skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those skilled in the art are deemed to be within the spirit, scope and concept of the invention as defined.

We claim:

1. A frequency selective surface comprising:
a plurality of resonators which are spherically shaped and have an arrangement which defines a periodic array of rows and columns, the periodic array extending in at least two orthogonal directions;
a registration structure which is arranged so that it at least partially maintains a position of each of the resonators in a predetermined spatial relationship with respect to adjacent ones of the plurality of resonators to define the array; and
each of the resonators formed of a conductive material and electrically insulated from adjacent ones of the plurality of resonators by an insulator material.

2. The frequency selective surface according to claim 1, wherein each of the resonators in the periodic array is aligned in a plane which extends in the at least two orthogonal directions and through a center of each of the plurality of resonators.

3. The frequency selective surface according to claim 1, wherein the periodic array of resonators defines a plurality of points which together define an array surface that includes at least one surface contour whereby the array surface extends in at least one direction transverse to the at least two orthogonal directions.

4. The frequency selective surface according to claim 1, wherein each of the plurality of resonators is surrounded by a dielectric coating layer of predetermined thickness.

5. The frequency selective surface according to claim 4, wherein the registration structure is comprised of the dielectric coating layer.

6. The frequency selective surface according to claim 5, wherein a spacing between adjacent ones of the resonators is maintained by the dielectric coating layer, and the spacing is equal to twice the predetermined thickness.

7. The frequency selective surface according to claim 4, wherein the insulator material which electrically insulates adjacent ones of the plurality of resonators includes at least the dielectric coating layer.

8. The frequency selective surface according to claim 1, wherein the registration structure is comprised of a core material which extends in one or more of the two orthogonal directions, the core material formed of a non-conductive dielectric material and having a periodic interstitial cell structure within which the resonators are disposed.

9. The frequency selective surface according to claim 1, wherein the registration structure is comprised of a core material which extends in one or more of the two orthogonal directions, the core material formed of a non-conductive dielectric material, and wherein the resonators are enclosed within the core material.

10. A method of forming a frequency selective surface comprising:
applying a coating layer formed of a dielectric material to individually surround each of a plurality of spherically shaped conductive resonators;
after applying the coating layer, arranging the plurality of spherically shaped conductive resonators to form a periodic array of rows and columns so that the periodic array extends in at least two orthogonal directions;
using the coating layer to maintain a desired spacing between adjacent ones of the resonators comprising the periodic array and to electrically insulate the adjacent ones of the plurality of spherically shaped conductive resonators.

11. The method according to claim 10, further comprising aligning each the spherically shaped conductive resonator forming the periodic array in a plane which extends in the at least two orthogonal directions.

12. The method according to claim 10, further comprising conforming the periodic array to a non-planar array surface comprising at least one surface contour.

13. The method according to claim 10, wherein the desired spacing is maintained at a distance which is equal to twice the predetermined thickness.

14. The method according to claim 10, further comprising disposing the plurality of spherically shaped conductive resonators within a core material which extends in one or more of the two orthogonal directions, the core material formed of a non-conductive dielectric material and having a periodic interstitial cell structure.

15. The method according to claim 10, further comprising flowing a non-conductive dielectric material around the plurality of spherically shaped conductive resonators, and fixing the spherically shaped conductive resonators in a fixed position by allowing the non-conductive dielectric material to cure.

16. The method according to claim 10, further comprising selecting one or more of a diameter of the spherically shaped conductive resonators and a thickness of the coating layer to obtain a predetermined frequency response for the frequency selective surface.

17. A method of forming a frequency selective surface comprising:
arranging a plurality of spherically shaped conductive resonators to form a periodic array of rows and columns;
conforming the periodic array to a non-planar surface which has at least one surface contour;
selecting a diameter of the spherically shaped conductive resonators and a spacing between adjacent ones of the spherically shaped conductive resonators in forming the array to obtain a predetermined frequency response for the frequency selective surface; and
maintaining a positional relationship among the spherically shaped conductive resonators in the rows and columns by securing the plurality of spherically shaped conductive resonators using a registration structure.

18. The method according to claim 17, further comprising prior to the arranging, applying a coating layer formed of a dielectric material to individually surround each of the plurality of spherically shaped conductive resonators.

19. The method according to claim 18, further comprising using the coating layer to maintain a desired spacing between adjacent ones of the resonators comprising the periodic array and to electrically insulate the adjacent ones of the plurality of spherically shaped conductive resonators.

20. The method according to claim 17, further comprising forming the registration structure by flowing a dielectric material around the spherically shaped conductive resonators, and allowing the dielectric material to cure with the spherically shaped conductive resonators contained therein.
